(19) United States
(12) Patent Application Publication
(10) Pub. No.: US 2017/0075134 A1
(43) Pub. Date: Mar. 16, 2017

(54) EYEGLASSES TEMPLE STRUCTURE

(71) Applicant: PROHERO GROUP CO., LTD., Tainan City (TW)

(72) Inventor: PEN-WEI CHEN, TAINAN CITY (TW)

(21) Appl. No.: 14/853,089

(22) Filed: Sep. 14, 2015

(51) Int. Cl. G02C 5/22; G02C 3/00; G02C 5/14

(52) U.S. Cl. CPC G02C 5/2209; G02C 5/146; G02C 3/003; G02C 2200/08

(57) ABSTRACT

This invention is related to an eyeglasses temple structure. Two assembly slots are formed at two ends of a frame for assembling with a positioning element, respectively. A pivot element is pivoted on the assembly slot through a hinge part of the positioning element. A protruding part at a wearing portion is inserted into the assembly slot through an end opening of the frame, and the protruding part has a pit for embedding and fixing an embedding part of the hinge part. Therefore, when the wearing portion is assembled with the frame, the wearing portion is positioned via the positioning element which is pivoted on the frame. When replace the wearing portion, the positioning element is pressed to enable the wearing portion to separate from the frame, so the replacement of the wearing portion is more quickly, easy, and convenient.

### BACKGROUND OF THE INVENTION

Field of the Invention

The present invention relates to an eyeglasses temple structure. More particularly, in the eyeglasses temple structure of the present invention, it is more quickly, easy, and convenient to replace the wearing portion.

Description of Related Art

The general glasses are divided into optical glasses, sunglasses, sport spectacles, and safety glasses, according to their uses and function. The frame design of different type of the glasses is different. For example, in the full-rim glasses, the lens is all received in the frame for protecting the safety of the lens, so the full-rim glasses are used in optical glasses with expensive lens. However, the half-rim glasses is lighter than the full-rim glasses, so it is used in sunglasses, sports spectacles, and safety glasses, which emphasis in light weight and well-executed, for user doing sport, outside exercise, or construction.

Whatever the glasses is applied for, the basic structure of the glasses comprises the lens assembled with the frame. The lens is assembled with the assembly hole of the frame and fixed in the screw hole which is in the assembly hole of the frame by the screws, so the lens is held between the assembly holes of the frame. Then, the temples are pivoted on the two sides of the frame by pivot elements to complete the assembly of the glasses.

The temples of the foregoing glasses could be pivoted on the two sides of the frame by pivot elements for user wearing on, but in actually use, it is found that when the temple is pivoted on the frame by the pivot element, it needs an additional tool to screw or release the pivot element, resulting that it is inconvenient to assemble or separate the temple. If there is no suitable tool, the temples could not be assembled or separated, so the user cannot replace the different type of the temple or the strap quickly according to different requirement. It is inconvenient in use.

### SUMMARY OF THE INVENTION

Therefore, the object of the present invention is related to an eyeglasses temple structure. When the wearing portion is assembled with the frame, the wearing portion is positioned via the positioning element which is pivoted on the frame. When replace the wearing portion, the positioning element is pressed to enable the wearing portion to disassemble with the frame, so the replacement of the wearing portion is more quickly, easy, and convenient.

For the above object, an eyeglasses temple structure comprises a frame, a positioning element, and a wearing portion.

The frame comprises two assembly slots at two ends of the frame respectively. Each assembly slot comprises an end opening which runs through the end of the frame and a through hole at the center of the assembly slot for inserting a pivot element.

The positioning element is assembled with one of the assembly slot and comprises a hinge part, an embedding part, and a press part. The hinge part is at the center of the positioning element and corresponded to the through hole of the assemble slot for pivoting the pivot element of the frame. The embedding part is protruded from one end of the positioning element which end is corresponded to the end opening of the assembly slot. The press part is at the other end of the positioning element.

The wearing portion comprises a protruding part and a pit. The protruding part is corresponded to the end opening of the frame for inserting the wearing portion into the end opening of the frame. The pit is opened at the protruding part and corresponded to the embedding part of the positioning member for embedding the embedding part.

According to one embodiment of the present invention, the foregoing wearing portion is a temple.

According to the other embodiment of the present invention, the foregoing wearing portion is a strap.

### BRIEF DESCRIPTION OF THE DRAWINGS

FIG. 1 is an exploded view of an eyeglasses temple structure according to an embodiment of the present invention;

FIG. 2 is an exploded view of an eyeglasses temple structure according to another embodiment of the present invention;

FIG. 3 is a three-dimensional view of the eyeglasses temple structure of FIG. 1;

FIG. 4 is a sectional view of the eyeglasses temple structure of FIG. 1;

FIG. 5 is a sectional view of the eyeglasses temple structure of FIG. 1 when used.

### DETAILED DESCRIPTION OF THE PREFERRED EMBODIMENT

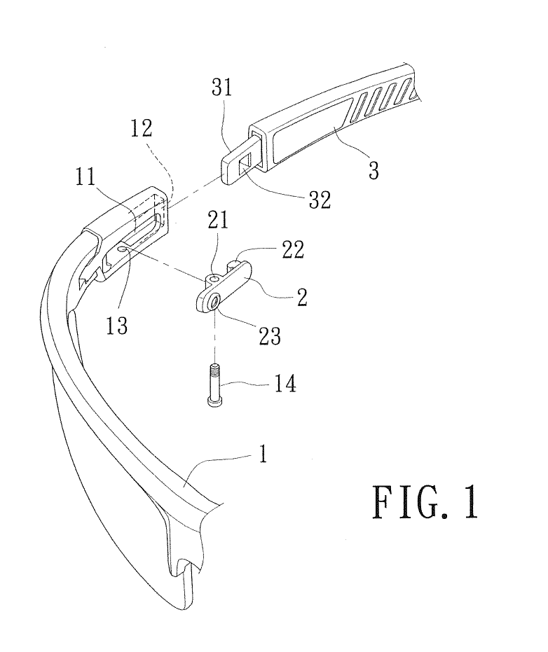

Please refer to FIG. 1, which is an exploded view of an eyeglasses temple structure according to an embodiment of the present invention. The eyeglasses temple structure comprises a frame 1, a positioning element 2, and a wearing portion 3.

The frame 1 comprises two assembly slots 11 at two ends of the frame 1 respectively. Each assembly slot 11 comprises an end opening 12 which runs through the end of the frame 1 and a through hole 13 at the center of the assembly slot 11 for inserting a pivot element 14.

The positioning element 2 is assembled with one of the assembly slot 11 and comprises a hinge part 21, an embedding part 22, and a press part 23. The hinge part 21 is at the center of the positioning element 2 and corresponded to the through hole 13 of the assemble slot 11. The embedding part 22 is protruded from one end of the positioning element 2 which end is corresponded to the end opening 12 of the assembly slot 11. The press part 23 is at the other end of the positioning element 2.

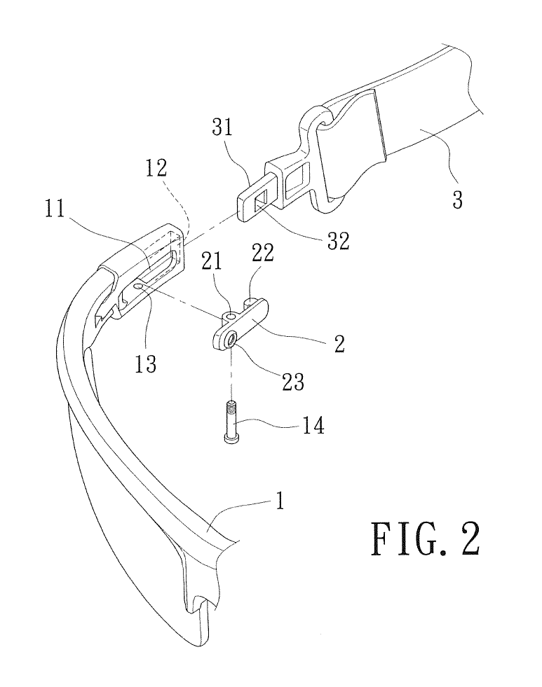

Please refer to FIG. 2, which is an exploded view of an eyeglasses temple structure according to another embodiment of the present invention. The wearing portion 3 is a temple or a strap. The wearing portion 3 comprises a protruding part 31 and a pit 32. The protruding part 31 is corresponded to the end opening 12 of the frame 1. The pit 32 is opened at the protruding part 31 and corresponded to the embedding part 22 of the positioning member 2.

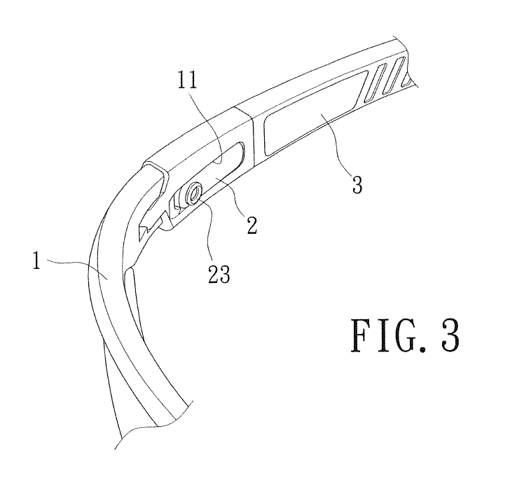

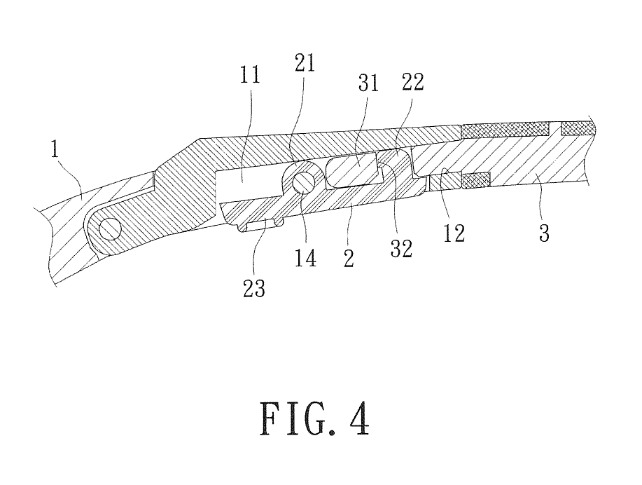

Please refer to FIG. 3 and FIG. 4, which are a three-dimensional view of the eyeglasses temple structure of FIG. 1 and a sectional view of the eyeglasses temple structure of FIG. 1. The positioning element 2 is assembled in the assembly slot 11 of the frame 1, and the pivot element 14 of the frame 1 is inserted into the through hole 13 to connect to the hinge part 21 of the positioning part 2. The protruding part 31 of the wearing portion 3 is inserted into the assembly slot 11 from the end opening 12 of the frame 1. And then, the wearing portion 3 and the frame 1 are assembled by the connection between the embedding part 22 of the positioning element 2 and the pit 32 of the wearing portion 3.

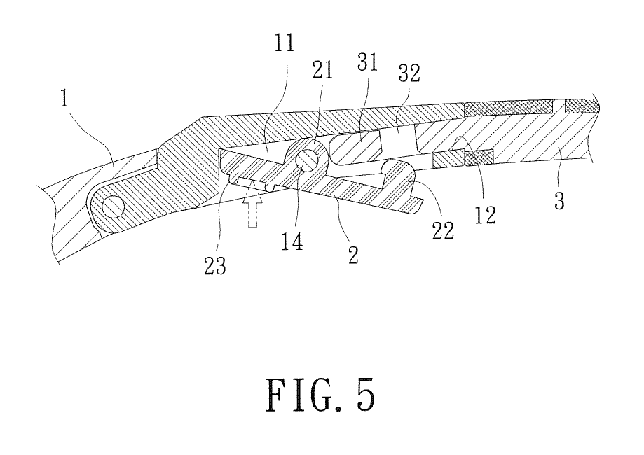

Please refer to FIG. 5, which is a sectional view of the eyeglasses temple structure of FIG. 1 when used. When the wearing portion 3 of the present invention is replaced, the press part 23 of the positioning element 2 is pressed to let the positioning element 2 pivot on the hinge part 21, so the press part 23 is moved into the assembly slot 11 of the frame 1 after pressed, correspondingly, the embedding part 22 of the positioning element 2 is moved out the assembly slot 11 and then the embedding part 22 is separated from the pit 32 of the wearing portion 3. Therefore, the protruding part 31 of the wearing portion 3 is separated from the end opening 12 of the frame 1, and then the wearing portion 3 could be replaced.

According to the above description and embodiments, in the eyeglasses temple structure of the present invention, after the wearing portion and the frame is assembled, the wearing portion is embedded and fixed by the positioning element which is pivoted on the frame. When the wearing portion is replaced, the positioning element is pressed to enable the wearing portion to separate from the frame, so it is much easy, quickly, and convenient to replace the wearing portion.

1. An eyeglasses temple structure, comprising:
a frame having two assembly slots formed respectively at two ends thereof, wherein each assembly slot communicating with an end opening formed at one end of the frame, the frame having a through hole formed therein to communicate with the assembly slot for receiving a pivot element;
a positioning element assembled with one of the assembly slots and pivotally coupled to the frame by the pivot element, the position element including:
a hinge part corresponding to the through hole of the assembly slot for receiving the pivot element;
an embedding part protruding transversely at one end of the positioning element corresponding to the end opening of the frame; and
a press part at an opposing end of the positioning element, the hinge part being disposed intermediately between the embedding and press parts; and
a wearing portion including:
a protruding part extending through one end opening of the frame for insert into one assembly slot of the frame; and
a pit formed in the protruding part for engagement by the embedding part of the positioning element to retain the protruding part within the assembly slot of the frame.

2. The eyeglasses temple structure according to claim 1, wherein the wearing portion includes a temple.

3. The eyeglasses temple structure according to claim 1, wherein the wearing portion includes a strap.
